(19) United States
(12) Patent Application Publication
(10) Pub. No.: US 2015/0024817 A1
(43) Pub. Date: Jan. 22, 2015

(54) PLATFORM FOR TEACHING SOCIAL CURRICULUM

(71) Applicant: IF YOU CAN COMPANY, San Mateo, CA (US)

(72) Inventor: William Hawkins, San Mateo, CA (US)

(21) Appl. No.: 14/337,458

(22) Filed: Jul. 22, 2014

Related U.S. Application Data
(60) Provisional application No. 61/857,072, filed on Jul. 22, 2013.

(51) Int. Cl. A63F 13/822; G09B 5/06

(52) U.S. Cl. CPC A63F 13/822; G09B 5/065
USPC 463/9

(57) ABSTRACT

An episode structure and API are disclosed for interweaving multiple game threads into gameplay experiences of virtual worlds such that players have clarity about overall story arcs and their mission purposes but find that, as they pursue those purposes, they continue to experience quests and events that teach them SEL principles that they need to learn based on their level and needs. In some aspects, successful execution or completion of SEL episodes can thwart or enable overall achievement of mission purposes and players that struggles are educated about what they did wrong through an empathy process.

### BACKGROUND OF THE INVENTION

Social learning is intended to help individuals, including children and adults, develop fundamental skills viewed as being needed to be effective and even successful in a variety of aspects of life. Social and emotional skills can be directed to enabling individuals to handle themselves, their relationships, and their work, both effectively and ethically. Some examples of these skills can include recognizing and managing social situations, recognizing and managing emotions, developing care and concern for others, developing care and concern for communities and the environment, establishing positive relationships, making responsible decisions, and handling challenging situations constructively and ethically.

Accordingly, what is desired is to solve problems related to teaching social and emotional learning skills, some of which may be discussed herein. Additionally, what is desired is to reduce drawbacks relating to incorporating social curriculum content into educational games, some of which may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be to present some innovations, embodiments, and/or examples found within this disclosure in a simplified form as a prelude to a more detailed description presented later.

As discussed above, social learning is intended to help individuals, including children and adults, develop fundamental skills viewed as being needed to be effective and even successful in a variety of aspects of life. For children, these skills are viewed as ways that enable them to calm themselves when angry, make friends, and resolve conflicts respectfully. It is anticipated that these skills enable a child to make ethical and safe choices as they grow and experience new situations. These skills are also viewed as ways that enable them to prepare for adulthood, citizenship, or chosen professions. For example, when children work together on team projects, they learn to collaborate, communicate, and resolve conflicts. Cooperative learning and character development can support the social and emotional development of children and prepare children for success in the modern workplace.

Many programs that teach social and emotional learning (SEL) skills have been evaluated and found to have positive impacts. According to some areas of research, schools are a highly effective setting for teaching social and emotional learning skills when they are implemented in a coordinated manner, school wide, from preschool through high school. Additionally, lessons are most effective when reinforced such as in the classroom, during out-of-school activities, and at home where families and schools work together to promote a children's social, emotional, and academic success.

One modern school of thought believes that social and emotional learning is one of the most important strategies to promote student success and effective school reform. Some researchers have found that social and emotional learning enhances academic achievement, helps students develop self-management and self-control, improves relationships at all levels of the school-community, reduces conflict among students, improves teachers' classroom management, and helps young people to be healthier and more successful in school and life.

Accordingly, what is desired is to solve problems relating to teaching social and emotional learning skills, some of which may be discussed herein. For example, it has been observed that when individuals have free time, they often prefer to use their computers for recreational activities that are more likely to be fun and engaging rather than for educational purposes. Even when children understand the importance of learning about and engaging in healthy behaviors, they typically still choose activities that are perceived to be fun rather than educational.

One way to make learning social and emotional learning skills more enticing is to present the information in a way that is more entertaining. Specifically, one way to make learning social and emotional learning skills more entertaining is to incorporate it into games. By incorporating social and emotional learning skills into game, such as a console-based or online game, the presentation of the information becomes more interesting to a player than the presentation offered at using traditional means that simply allow individuals to browse information or search directly for it.

Accordingly, there is a need for a platform that will simplify the process for teaching social curriculum. In one aspect, the platform provides social and emotional learning experts (e.g., those in global warming, ethics, etc.) tools to create games that teach a lesson. Additionally, what is desired is to reduce drawbacks relating to creating incorporating existing content teaching social and emotional learning skills into new platforms, some of which may be discussed herein.

For example, there is a need to allow non-programmers to onboard SEL content in a virtual with without requiring programming knowledge. This facilitates subject matter experts and consumers in the creation of content. There is also a need to prevent consumers from get tired of repetition and churn out due to boredom. Children in particular churn out because they aspire to be like older kids but are copied by younger siblings and drop out because the software no longer feels aspirational or “cool.” Therefore, there is a need to adapt game content and game play based on attributes of a game player.

Game players win or lose and may try again, but lack perspective about the consequences of their decisions due to a lack of accountability and an inability to understand where things went wrong and how to fix it.

Most games are action games and it is problematic to make an interesting or emotionally meaningful game that depends on dialogue. There are no games or interactive software systems known to the inventors that do an effective job of creating accurate, poignant, emotionally powerful and life-changing moral experiences that change the values and character of the players.

Additionally, it is difficult to design a game world that can be scalable and expanded indefinitely without creating continuity errors or running out of space, or cluttering up the world with conflicting modalities. The popularity of game mechanics is constantly changing with new ones being “hot.”

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is a simplified illustration of a system that may incorporate an embodiment of the present invention.

FIG. 2 is a set of services that may incorporate an embodiment of the present invention.

FIG. 3 is a simplified flow diagram of content mapping in an embodiment of the present invention.

FIG. 4 is an illustration providing one example of a system for visualizing consequences of a player's choices in an embodiment of the present invention.

FIG. 5 is a simplified flowchart of a method implementing a programmable karma system in an embodiment of the present invention.

FIG. 6 is a simplified flowchart of a method implementing choice-consequence preview system in an embodiment of the present invention.

FIG. 7 is a simplified flowchart of a method for customizing episodic play in an embodiment of the present invention.

FIG. 8 is a screenshot of a dialogue flow in an embodiment of the present invention.

FIG. 9 is a simplified block diagram of a computer system that may be used to practice embodiments of the present invention.

### DETAILED DESCRIPTION OF THE INVENTION

In various embodiments, a platform is disclosed that enables the creation of simulations of social interactions. Various tools are provided that enable the onboarding of various social curriculum into virtual worlds allowing participants of the virtual worlds to try various behaviors and observe the impact therefrom. Participants create and learn in the virtual worlds by exploring and experimenting. Thus, a social curriculum platform is disclosed that teaches, for example, social studies and humanities through virtual human relationships using gameplay mechanics and interactive stories.

A social curriculum platform is provided that uses fundamentals of game industry and Hollywood storytelling to present legitimate curriculum information/knowledge/teaching/practice in the context of a story. The social curriculum platform allows developers to organize curriculum topics and have “scoring buckets” (or other metrics) for each element. The social curriculum platform can determine player “academic test scores” by adjusting the bucket scores based on player game choices. The social curriculum platform can assess a participant and put the participant on an appropriate age/curriculum “track.” Ongoing, the social curriculum platform use a cycle to present, test, remediate or “pass and advance to next” curriculum.

In the case of social and emotional learning (SEL) content, for example, an episode structure and API are disclosed for interweaving multiple game threads into gameplay experiences of virtual worlds such that players have clarity about overall story arcs and their mission purposes but find that, as they pursue those purposes, they continue to experience quests and events that teach them SEL principles that they need to learn based on their level and needs. In some aspects, successful execution or completion of SEL episodes can thwart or enable overall achievement of mission purposes. Players that struggle are educated about what they did wrong, such as through an empathy process. Accordingly, in this process, SEL episodes that teach SEL skills become side-tangent story threads off an entertaining and engaging main arc. A programming toolkit and API are used to enable content developers to more readily incorporate SEL content into SEL episodes.

In various embodiments, the platform architecture allows all players to begin at a predetermined starting point, such as chapter 1 of an episode or story arc and proceed to chapter 2 and so as the play interacts with the virtual world. In one aspect, the platform may dynamically adjust the curriculum associated with each chapter or story segment based on an age, knowledge level, etc. of the player. Hence, in one example, a young beginner may get curriculum chapter 1 with story chapter 1, an older and wiser player may get curriculum chapter 27 with story chapter 1. This unique form allows all players to enjoy the same story and plot elements in the same order while being exposed to, for example, vocabulary, gameplay challenges, quests and curriculum difficulty that matches correctly with their wisdom and progress.

In order to better understand one or more of the inventions presented within this disclosure, aspects of at least one environment within which various embodiments may operate will first be described.

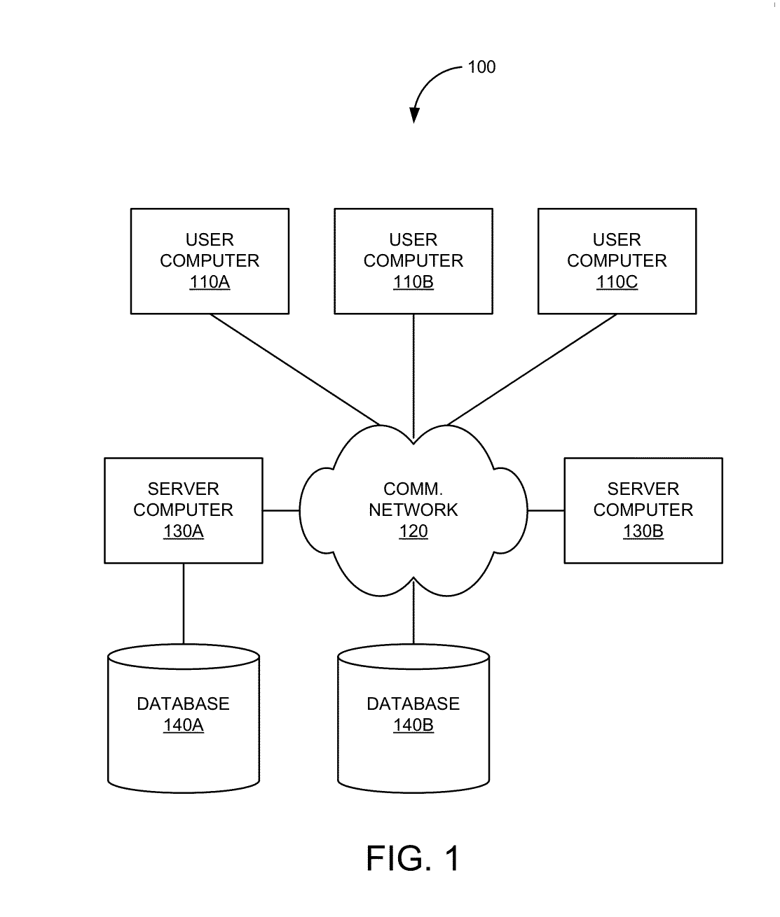

FIG. 1 is a simplified illustration of system 100 that may incorporate an embodiment or be incorporated into an embodiment of any of the innovations, embodiments, and/or examples found within this disclosure. FIG. 100 is merely illustrative of an embodiment incorporating the present invention and does not limit the scope of the invention as recited in the claims. One of ordinary skill in the art would recognize other variations, modifications, and alternatives.

In one embodiment, system 100 includes one or more user computers 110 (e.g., computers 110A, 110B, and 110C). User computers 110 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 110 can also have any of a variety of applications, including one or more applications configured to perform methods of the invention, as well as one or more office applications, database client and/or server applications, and web browser applications.

Alternatively, user computers 110 can be any other electronic device, such as a thin-client computer, Internet-enabled mobile telephone, and/or personal digital assistant, capable of communicating via a network (e.g., communications network 120 described below) and/or displaying and navigating web pages or other types of electronic documents. Although the exemplary system 100 is shown with three user computers, any number of user computers or devices can be supported.

Certain embodiments of the invention operate in a networked environment, which can include communications network 120. Communications network 120 can be any type of network familiar to those skilled in the art that can support data communications using any of a variety of commercially-available protocols, including without limitation TCP/IP, SNA, IPX, AppleTalk, and the like. Merely by way of example, communications network 120 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 130 (e.g., computers 130A and 130B). Each of server computers 130 may be configured with an operating system including without limitation any of those discussed above, as well as any commercially-available server operating systems. Each of server computers 130 may also be running one or more applications, which can be configured to provide services to one or more clients (e.g., user computers 110) and/or other servers (e.g., server computers 130).

Merely by way of example, one of server computers 130 may be a web server, which can be used, merely by way of example, to process requests for web pages or other electronic documents from user computers 110. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 110 to perform methods of the invention.

Server computers 130, in some embodiments, might include one ore more file and or/application servers, which can include one or more applications accessible by a client running on one or more of user computers 110 and/or other server computers 130. Merely by way of example, one or more of server computers 130 can be one or more general purpose computers capable of executing programs or scripts in response to user computers 110 and/or other server computers 130, including without limitation web applications (which might, in some cases, be configured to perform methods of the invention).

Merely by way of example, a web application can be implemented as one or more scripts or programs written in any programming language, such as Java, C, or C++, and/or any scripting language, such as Perl, Python, or TCL, as well as combinations of any programming/scripting languages. The application server(s) can also include database servers, including without limitation those commercially available from Oracle, Microsoft, IBM and the like, which can process requests from database clients running on one of user computers 110 and/or another of server computers 130.

In some embodiments, an application server can create web pages dynamically for displaying the information in accordance with embodiments of the invention. Data provided by an application server may be formatted as web pages (comprising HTML, XML, Javascript, AJAX, etc., for example) and/or may be forwarded to one of user computers 110 via a web server (as described above, for example). Similarly, a web server might receive web page requests and/or input data from one of user computers 110 and/or forward the web page requests and/or input data to an application server.

In accordance with further embodiments, one or more of server computers 130 can function as a file server and/or can include one or more of the files necessary to implement methods of the invention incorporated by an application running on one of user computers 110 and/or another of server computers 130. Alternatively, as those skilled in the art will appreciate, a file server can include all necessary files, allowing such an application to be invoked remotely by one or more of user computers 110 and/or server computers 130. It should be noted that the functions described with respect to various servers herein (e.g., application server, database server, web server, file server, etc.) can be performed by a single server and/or a plurality of specialized servers, depending on implementation-specific needs and parameters.

In certain embodiments, system 100 can include one or more databases 140 (e.g., databases 140A and 140B). The location of the database(s) 140 is discretionary: merely by way of example, database 140A might reside on a storage medium local to (and/or resident in) server computer 130A (and/or one or more of user computers 110). Alternatively, database 140B can be remote from any or all of user computers 110 and server computers 130, so long as it can be in communication (e.g., via communications network 120) with one or more of these. In a particular set of embodiments, databases 140 can reside in a storage-area network (“SAN”) familiar to those skilled in the art. (Likewise, any necessary files for performing the functions attributed to user computers 110 and server computers 130 can be stored locally on the respective computer and/or remotely, as appropriate). In one set of embodiments, one or more of databases 140 can be a relational database that is adapted to store, update, and retrieve data in response to SQL-formatted commands. Databases 140 might be controlled and/or maintained by a database server, as described above, for example.

In various embodiments, system 100 includes hardware and/or software elements configured for teaching social emotional learning (SEL) curriculum. Aspects and features referred to herein with respect to system 100 can equally apply to other types of content, such as content that has to do with human behavior, psychology, ethics, values, and the like. Additionally, aspects and features referred to herein with respect to system 100 are applicable to other forms of curriculum learning and behavioral adaptation.

Virtual Worlds

In one embodiment, system 100 provides a platform for creating, operating, and distributing computerized simulations that teach social learning in virtual worlds. In general, system 100 provides a platform with special tools and APIs that enable non-programmers to create a new kind of game content episode that conforms to a unique dialogue system. In various embodiments, the dialogue system allows a developer to communicate a story as well as script adventures and interactions that entertain in addition to teach social curriculum in the virtual world. The virtual world may be hosted on a desktop computer system, a gaming or entertainment console, a portable entertainment device, a smartphone, and the like. A virtual world may further be hosted at an online service accessible over the Internet or other communications network and made available via clients installed on a desktop computer system, a gaming or entertainment console, a portable entertainment device, a smartphone, and the like.

A virtual world can include any online community of one or more players. The virtual world may take the form of a computer-based simulated environment through which users can interact with non-player characters (NPCs), other players, and/or use and create virtual objects. As is known in the art, virtual worlds may depict a wide range of worlds, including those based on fantasy, science fiction, the real world, super heroes, sports, horror, and historical milieus. A virtual world may be an interactive 3D virtual environment where users take the form of avatars visible to others. An avatar can include any textual, two-dimensional, or three-dimensional representations of the user, a persona, personality, or fictitious character.

In general, a computer or other device accesses a computer-simulated world and presents perceptual stimuli to a user or player, who in turn can manipulate elements of the modeled world and thus experience a degree of telepresence. Such modeled worlds and their rules may draw from the reality or fantasy worlds. Example rules are gravity, topography, locomotion, real-time actions, and communication. Communication between users can range from text, graphical icons, visual gesture, sound, and, forms using touch, voice command, and balance senses.

In some embodiments, participants interact with virtual worlds through content and/or functionality including, but not limited to, teaching social curriculum skills. In one aspect, each virtual world includes content and/or functionality similar to the addiction and interest of Pokémon™ and Angry Birds™ but also includes content and/or functionality that teach skills, such as SEL skills. In various embodiments, the content and/or functionality that teach SEL skills may be embodied in the form of SEL episodes. Therefore, system 100, in one aspect, provides a virtual world that teaches ethics and values to children at age and experience appropriate levels while also serving as an entertainment platform. In some aspects, system 100 provides one or more virtual worlds each with age-appropriate experiences so that players grow through the experiences. In further aspects, system 100 provides one or more virtual worlds where younger players aspire to do what older players are doing.

In one aspect, an episode includes content (e.g., imagery, sound, and dialogue) and/or functionality (e.g., gameplay) that provides an opportunity for a player to engage in an experience during which the player learns and/or applies skills taught by the episode. In some aspects, curriculum in an episode may be taught through a single game or through multiple online interactions. In other aspects, episodes may be interwoven into one or more threads of a gameplay experience that enables a player to engage in an overall story arc with a heroic mission purpose that, as they pursue that purpose, allows them to continuously experience quests and events at each episode that teaches and builds upon principles of an associated curriculum.

In further embodiments, system 100 provides a platform that enables experts in a variety of areas, from global warming to ethics, educators, mentors, and parents, to create games in a virtual world that teach a desired lesson. System 100 leverages available sources of social curriculum content that can be incorporated into episodes. For example, research about the Stanford prison experiment dilemma, where when some students were prisoners and others were guards and the guards over time became cruel and tortured the prisoners stopping the experiment, can be incorporated into SEL episodes and presented in age-experience appropriate manners to players in order to learn SEL skills and potentially gain insight into their own behavior.

In further embodiments, system 100 enables organizations (such as civic, academic, religious, and charitable entities) and individuals (such as parents, educators, and celebrities) to be involved in creating content that promotes lifestyle and behavioral choices that may be presented to a player. Parents may include or exclude content that will be presented to their children according to their own moral code. In another example, celebrities may authorize the use of their brand and voiceovers to endorse a certain point of view or a desired “societal norm.”

System 100, provides other features and improvements, some of which may include but not limited to the ability to incorporate and onboard curriculum design from experts, the ability to onboard story structures from famous human culture, the ability to add or swap in and out game mechanics to maintain popularity, the ability to scale world indefinitely due to structure of planets and planetside organization, a theme park type layout organized to dynamically open or close elements based on player attributes, a programmable dialogue system to allow moral lessons to be taught with consequences, aging of avatars in many respects, a picture of Dorian Gray karma system, parallel dashboards—one with achievements for child from child's heroic perspective, and for parent with learning perspective, parental controls over dynamic episodic content being included or excluded (e.g., “sex” is OFF, “racism” is ON), the ability of player to see, through their conscience spirit, what they did in the past that created a bad outcome, the ability of player to go back and re-do with a makeover, the ability of player to time travel forward or back to see consequences or fix problems, the ability of player to be turned into different creatures and characters to walk in their shoes and feel their situation intimately.

System 100 further provides for a player vs environment situations, in some embodiments, virtual worlds in which stories and player missions can be added as SEL episodes and in which the world is coded in such a fashion that only certain episodes of relevance to each player are exposed and the world dynamically reconfigures to have integrity and continuity within those choices. Further, the world opens and closes sections based on the age and other elements of progress of the player (including, but not limited to, how the player's parent/guardian has made choices about which types of learning episodes to experience or not). As the player successfully completes episodes and learns lessons the world continues to dynamically change to age and grow both the world and its opportunities and the player's position in it that includes the awareness of the world's features as well as the appearance and other features of the player's avatar.

In some aspects, system 100 provides SEL episodes where players encounter and interact with other characters (e.g., other players or non-player characters), and be forced to make choices. In some embodiments, system 100 allows a player to obtain advice from a guide. System 100 may further show the player, through the use of a computer-controlled “conscience avatar” what they did and why it was wrong.

In further embodiments, system 100 allows a player to go into the future or the past to see the consequences of decisions made at any point in time (e.g., like the ghosts of the future and past in Scrooge). In some aspects, system 100 includes functionality enabling a player to go back in time to correct a decision that fails to satisfy predetermined criteria (e.g., a “bad” decision). Accordingly, system 100 enables the player to time travel into the future to see consequences or time travel into the past to repeat dialogue and decision tree branching to fix problems and correct the future.

In further aspects, system 100 provides other feedback mechanisms and dashboard for parents, guardians, and educators to review a players progress. System 100 remembers player choices and creates “karma” from them. Such karma may be tracked using a variety of mechanisms, one being a “picture of Dorian Gray” method that holds players completely accountable. For example, a player's avatar or in-world persona may be compared to “a picture of Dorian Gray” style visual representation wherein the picture change (e.g., ages) while the character stays ageless to reflect when a player's choices fail to satisfy the predetermined criteria.

For example, a player's avatar may age over time to maintain an appearance consistent with the age and changing appearance of the human player and of their accomplishments in the game world. In some embodiments, system 100 may adapt a player's avatar to change in size and shape, grow facial hair, change the angles of facial bones and in other ways appear to “mature.” In further embodiments, system 100 may further adapt characters a player encounters or has encountered to also age with them in order to present to them a more attractive and coherent “peer” and aspirational world. In one aspect, a computer-controlled characters may generally appear to be older and more sophisticated than the player's avatar, but the avatar would “grow up” as it accomplishes things in the game world.

System 100 may provide a mechanism whereby feedback is given to the player based on player choices. One possible feedback is that an avatar for the player will become better or worse, older or younger, meaner or happier depending upon the results. Another possible feedback is a conscience character (similar to Jiminy Cricket or an angel of the player's shoulder) that provides hints to guiding the players actions or choice in an episode and reinforcing that such behavior is also acceptable in the real world.

Episodic Content

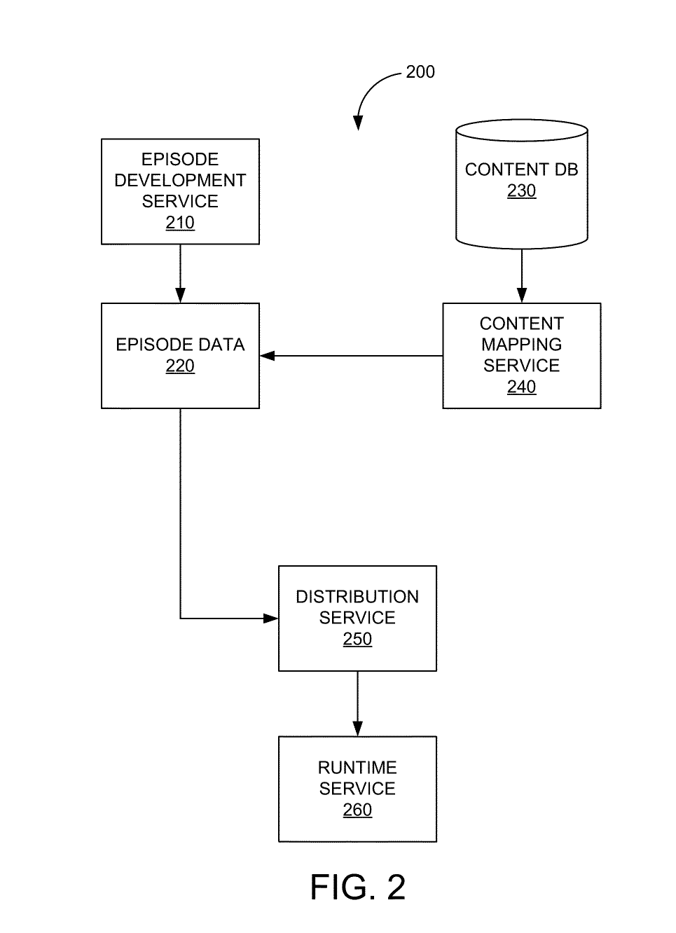

FIG. 2 is a set of services 200 that may incorporate an embodiment of the present invention. In this example, services 200 include episode development service 210 that generates episode data 220. Episode data 220 is complemented or adapted with content obtained from content database 230 through one or more user using content mapping service 240. Episode data 220 can be distributed to end user or further services through distribution service 250. Runtime service 260 provides an end user experience for each episode.

Episode development service 210 includes hardware and/or software elements configured to provide development tools for creating an SEL episode. Some examples of episode development service 210 include integrated development environments (IDEs), programming toolkits, game development engines, console development platforms, and the like.

Episode data 220 includes content and/or functionality for delivering an experience. Some examples of content that may be included in episode data 220 are multimedia information, imagery, videos and animation, audio/visual effects, dialogue, and the like. Some examples of functionality that may be included in episode data 220 are program code, script code, game engines and state, artificial intelligence routines, animation sequences, and the like.

In some aspects, episode data 220 may include a working functionality framework with no or minimal content. Additional content and how the content is presented and consumed may be incorporated into episode data 220 using content mapping service 240. Content mapping service 240 includes hardware and/or software element configured to enable users (e.g., experts in a variety of areas, from global warming to ethics, educators, mentors, and parents) to incorporate content from content database 230 into episode data 220. Content may be incorporated as multimedia information, imagery, videos and animation, audio/visual effects, dialogue, and the like. In further aspects, content may be incorporated into results information obtained through use of functionality programmed into episode data 220 to drive further gameplay or feedback systems.

In one example, episode development service 210 enables a develop to generate textual content for a game engine. The textual content provides a script that the game engine interprets to communicate a story and simulations of social interactions. A dialog editor can be used to populate dialogues of an interaction between a player and a non-player character. In one aspect, a develop can provide, in addition to the text of an interaction and an associated dialog flow, decision trees that alter the text of the interaction or the associated dialog flow based on aspects of the curriculum being taught. For example, a developer creating content that teaches how to recognize emotions may script interactions such that the different emotional responses are provided according to a predetermined emotional state of a participant. In another example, interactions may be scripted such that emotional responses are escalated or deescalated according to the dialog flow.

In another example, content can be mapped to populate an anticipated desired result of the interaction and to create one or more teaching opportunities that may result from failure to achieve the desired result. In one aspect, answers in dialogues can be ranked by correctness for the purposes of organization and accuracy in later scoring/assessment. System 100 may randomize the order in which the answers are presented to a user.

Accordingly, episode development service 210 allows the core functionality and programming of the game engine to remain intact. Content remains data and does not need to become executable program code. Hence, the program code of the game engine can be changed very infrequently which means that it can be submitted to a platform, e.g., Apple iTunes, very rarely, but then allow numerous episodes to be onboarded, such as on a server, as additional data files that talk to an existing episode/gameplay API of system 100. This is more convenient for the game content publisher who need not get in line and wait again and again for Apple approval, and also for consumers who need not do constant Update Downloads to maintain the program accuracy. Instead, by following this model and adding the data content to the server things are easier and more convenient for all.

In one embodiment, episode data 220 is outlined in general to include at least a story and associated dialog scripting. Each of these can then be broken down into a specific description that is age-appropriate. Age-appropriate in this context can mean biological age and/or curriculum age. Content mapping service 240 is used to have dialogue adjusted and edited for each age. For example, what situation and data files involving the topic of Sex would be mild for a five year old (e.g., learning that it is inappropriate to touch themselves in certain areas in public, and that they must respect the privacy of other people's bodies, especially the opposite sex); and more mature for a 10 year old (e.g., addressing human biology of reproduction) and more explicit for a teenager (e.g., social responsibility and STDs).

Dialogue is then added to the files, again being age-appropriate that now when a 5 year-old plays his gameplay engine knows his age and adds the right episodes to his gameplay story and adventure. Thus, on the fly adjusting of content to fit different ages of players allows episode code to be reused for different scenarios, concepts, and players.

In further embodiments, scripts can be are written such that a player may assume one of a set of player character species/races and the visuals, soundtrack and dialogue are all appropriate for the selected species. A data swap is used, for example, to make cat v dog instead of dog v cat. For example, a player can choose to be dog or cat and the data adjusts smoothly including art and dialogue changes.

Distribution service 250 includes hardware and/or software elements configured to distribute or otherwise deliver episode data 220 to end users or other intermediary distribution points. Some examples of distribution service 250 can include physical distribution channels as is known in the art as well as online distribution channels as is known in the art such as a website hosted on the Internet or an application store (such as the App Store™ provided by Apple, Inc. of Cupertino, Calif. or Google Play™ provided by Google, Inc. of Mountain View, Calif.).

Runtime service 260 includes hardware and/or software elements configured to enable players to interact with episode data 220. Runtime service 260 may include client software for connecting to a virtual world, a virtual machine or interpreter, or the like. Runtime service 260 may further be embodied as a mobile application loaded onto a portable entertainment device, such as a laptop, tablet, of iPad™.

Accordingly, system 200 illustrations elements of a platform for creating, operating, and distributing computerized SEL episodes in virtual worlds. SEL episode provide content (e.g., imagery, sound, and dialogue) and/or functionality (e.g., gameplay) that allow a player to engage in an experience during which the player learns and/or applies SEL skills. Content mapping service 240 facilitates content providers that are not programmers to organize and onboard SEL content directly into the data files of computerized SEL episodes without the intervention of a programmer by following a set of rules and conforming to the API as the data entry method.

SEL Content Mapping

In one embodiment, system 100 includes a programmable toolkit and an application programming interface (API) for mapping SEL expert content directly into data files of SEL episodes. As such, SEL episodes can be more easily create and updated using the programmable toolkit and API. SEL episodes can remain data without requiring to be compiled into executable program code. In one aspect, the platform allows the actual program code of an SEL episode program to change very infrequently facilitating submission to other services, such as iTunes provided by Apple Inc. of Cupertino Calif. Numerous episodes can be quickly created with mapped SEL content and onboarded server side as additional data files that talk to the existing episode/gameplay API. This is more convenient for the game content publisher who need not get in line and wait again and again for Apple approval, and also for consumers who need not do constant Update Downloads to maintain the program accuracy. Instead by following this model and adding the data content to the server things are easier and more convenient for all.

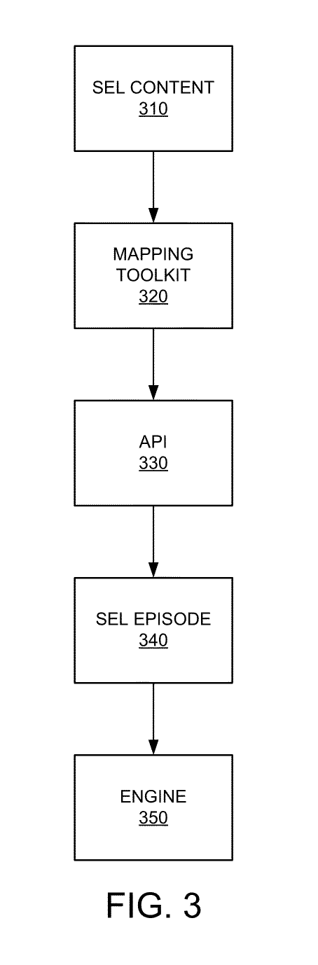

FIG. 3 is a simplified flow diagram of content mapping in an embodiment of the present invention. In this example, SEL content 310 is mapped using mapping toolkit 320 and API 330 into SEL episode 340. This allows episode 340 to be quickly created with mapped SEL content 310. SEL content 310 can be incorporated directly into SEL episode 340. Preferably, SEL content 310 is onboarded server side as additional data files that talk to an existing episode/gameplay API, such as API 340.

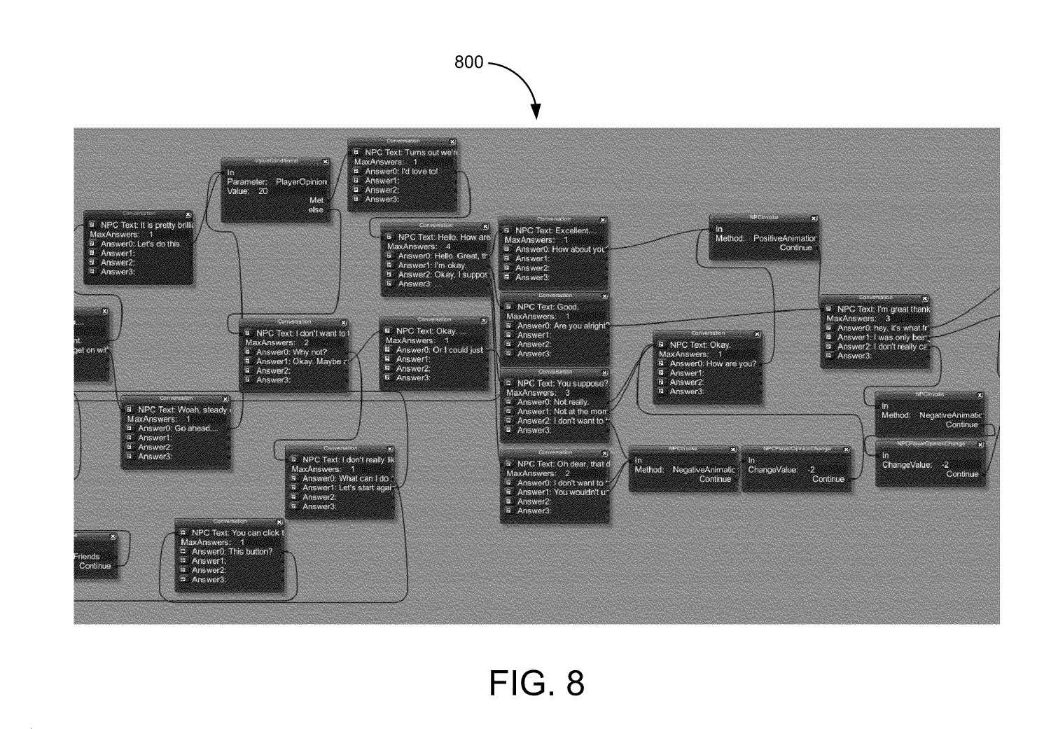

FIG. 8 is a screenshot of dialogue flow 800 in an embodiment of the present invention.

In one aspect, system 100 provides for SEL content 310 to conform to slightly different degrees of maturity and harshness in each episode. In another aspect, system 100 provides for SEL content 310 to further then be mapping to dialogue of non-player characters (NPCs) and into the choices offered to the player for his dialogue in responding to a framed SEL situation presented in the experience. For example, in some episodes a player will encounter other characters and be forced to make choices. SEL content 310 provides the choices to be made and the dialogue of these interactions. The player can get also advice obtained from or otherwise mapped from SEL content 310 from a guide. In various embodiments, system 100 enhances game play by ranking answers in dialogue by correctness but also randomizes the order in which participants see the choices.

In this example, engine 350 allows SEL episode 340 that has been downloaded to or installed in an easy fashion to be executed or played. Engine 350 can include one or more applications, virtual machines, game engines, or the like that enable game play. In one aspect, episode 340 can be updated or otherwise modified, such as when data is added to the server, without requiring modification to engine 350 or SEL episode 340. This allows new episodes to be created simply by altering the mappings with associated SEL content.

In some embodiments, SEL episode 340 may include information associated with one the following areas:

Self-Awareness (identifying emotions, self-confidence, self-efficacy)

Self-Management (impulse control, stress management, self-discipline, motivation, goal setting, organizational skills)

Social-Awareness (perspective taking, empathy, appreciating diversity, respect for others)

Relationship Skills (communication, social engagement, relationships, cooperation, resolving conflicts, seeking help or helping)

Responsible Decision Making (problem solving skills, ethical responsibility)

SEL episode 340 may include lessons designed to enhance a students' inter- and intra-personal skills in the following areas, Active Listening, Teamwork and Cooperation, Stewardship and Community Building, Friendship and Collaboration, and the like. SEL episode 340 may further include information for grading a player's progress according to predetermined criteria, such as Lowest—Not demonstrating, Okay—Developing, Good—Practicing, Great—Applying, or the like. In one aspect, SEL episode 340 may include information for grading the following:
Self-Awareness:
Recognizes feelings as they occur
Expresses emotions or feelings in age-appropriate manner
Exhibits self-confidence
Comfortable with own feelings and discussion about them
Understands when need assistance with handling a feeling or emotion
Communicates effectively to get one's needs met
Self-Management:
Able to regulate emotions so doesn't hinder a task at hand
Delays gratification to pursue a goal
Perseveres when has a setback
Can apply some tools/strategies when needing to change emotional state
Can apply some tools/strategies to handle physical/motor needs
Social Awareness:
Understands what others are feeling—empathetic
Ability to take other person's perspective
Appreciates differences
Able to interact with diverse personalities
Helps others
Relationship Skills:
Resolves/tries to resolve conflicts with words
Able to generate possibilities when in conflict
Able to respect different opinions
Actively listens to others:
Comfortable entering into social play/group experiences
Maintains social play/group experiences
Negotiates/effectively communicates needs with others
Seeks help from peers/adults when necessary
Cooperative/Collaborative Skill:
Has positive relationships with peers and adults
Can take a leadership role
Can take on role of follower
Listens and clarifies information
Encourages others
Responsible Decision Making:
Assesses a situation from different perspectives
Considers a situation with all relevant information
Considers consequences of alternative actions
Respects others
Takes personal responsibility for one's behaviors/decisions

In further embodiments, SEL episode 340 may be configured to report on a player's progress in terms of:
Resilience (Social-Emotional Acuity)
Adjusts to change (flexibility)
Takes risks/tries new things
Accepts that mistakes are a part of learning
Perseveres
Recovers from adversity appropriately
Seeks challenge
Possesses self-awareness
Tolerates ambiguity
Creativity and Critical Thinking (Life-long Learning)

Progress Tracking

In various embodiments, system 100 provides feedback mechanisms to adjust the flow of a story of an episode as well to enable a player or others to review progress in a virtual world. Accordingly, a developer may indicate metrics that are to be tracked as the player or participant engages in simulations of social interacts in one or more episodes. System 100 may utilize states of the participant, non-player characters, and the environment, with the tracked metrics to adjust the flow of a story of an episode as well to enable a player or others to review progress.

In one aspect, system 100 tailors game mechanics based on implied choices (e.g., walk past litter) and explicit choices in dialogue. In one embodiment, system 100 provides a method of collecting level points (or experience points) for aspects of a curriculum and leveling up a player when buckets are full. As discussed above, system 100 may adjusting gameplay, dialogs, and the curriculum taught based on advancement in a game.

For example, system 100 can track how a player ages or levels-up based on predetermined criteria and experience. A player's avatar may age over time to maintain an appearance consistent with the age and changing appearance of the human player and of their accomplishments in the game world. In some embodiments, system 100 may adapt a player's avatar to change in size and shape, grow facial hair, change the angles of facial bones and in other ways appear to “mature.” In further embodiments, system 100 may further adapt characters a player encounters or has encountered to also age with them in order to present to them a more attractive and coherent “peer” and aspirational world. In one aspect, a computer-controlled characters may generally appear to be older and more sophisticated than the player's avatar, but the avatar would “grow up” as it accomplishes things in the game world.

In one embodiment, avatar data aging can be achieved by using math scores to cause avatar body, facial, fashion, and animation visuals to be upgraded/changed as the player accomplishes more such as when transitioning from Level 7 to Level 8=becoming an 8 year-old in SEL/topic sophistication. Aging a player's avatar can be done very comprehensively including changes in height, maturity of appearance, facial hair and fashion details. Therefore, by tracking a player's advancement through challenges and episodes of the player's “age” (e.g., age 7) in addition to points for “graduation” and accomplishment, a player's avatar can gradually adapt and appear ready to be an 8 year-old and looking very different than when the player began as a 7 year old. Therefore, system 100 matures a player such that, for example, as a player begins to “feel” like a 3rd grader the player is less included to return to 2nd grade level gameplay. In further aspects, system 100 matures the world and the content that a player experiences based on time and other predetermined criteria, such as the player's determined emotional level or responses to interactions.

In another example, system 100 remembers player choices and creates “karma” from those choices. Such karma may be tracked using a variety of mechanisms. Karma may further be used to provide feedback to a player, one being a “picture of Dorian Gray” method that holds players completely accountable. For example, a player's avatar or in-world persona may be compared to “a picture of Dorian Gray” style visual representation wherein the picture change (e.g., ages) while the character stays ageless to reflect when a player's choices fail to satisfy the predetermined criteria.

In one aspect, player choices may include implied choices (e.g., walk past litter) and explicit choices (e.g., those made in dialogues). Portions of combinations of a player's choices (both implied and explicit) may be used to determine how collecting level points or experience are awarded, when a player levels, and how curriculum and player progress is modified based on advancement.

In one aspect, content is scripted to allow a participant during a social interaction to make predetermined choices or to choose freely. In some situations, a participant is given, for example, a multiple-choice test where the choices tie in to previously recorded voiceover and story. Presenting the choices runs a risk that the correct answer may have obviousness and a player in theory could learn to “game” the answers and appear to be learning SEL when what he is really “learning” is how to “win this particular video game.”

Accordingly, in some embodiments, system 100 assesses true learning and real-world transference. For example, system 100 may dynamically set up a player with “traps” they can fall into if they're not paying attention. In one example, a participant can be lured into the wrong choices to confirm that they don't know the right choices. In another example, system 100 can make choices appear to be similar so the right one does not stand out. One example of this is text length. In further embodiments, system 100 randomly organizes and presents choices minimizing patterns. In at least one embodiment, system 100 give NEGATIVE points for wrong choices. This means that a player choosing randomly cannot advance; it also means that a bad student is more likely to be detected as a bad student and given remediation.

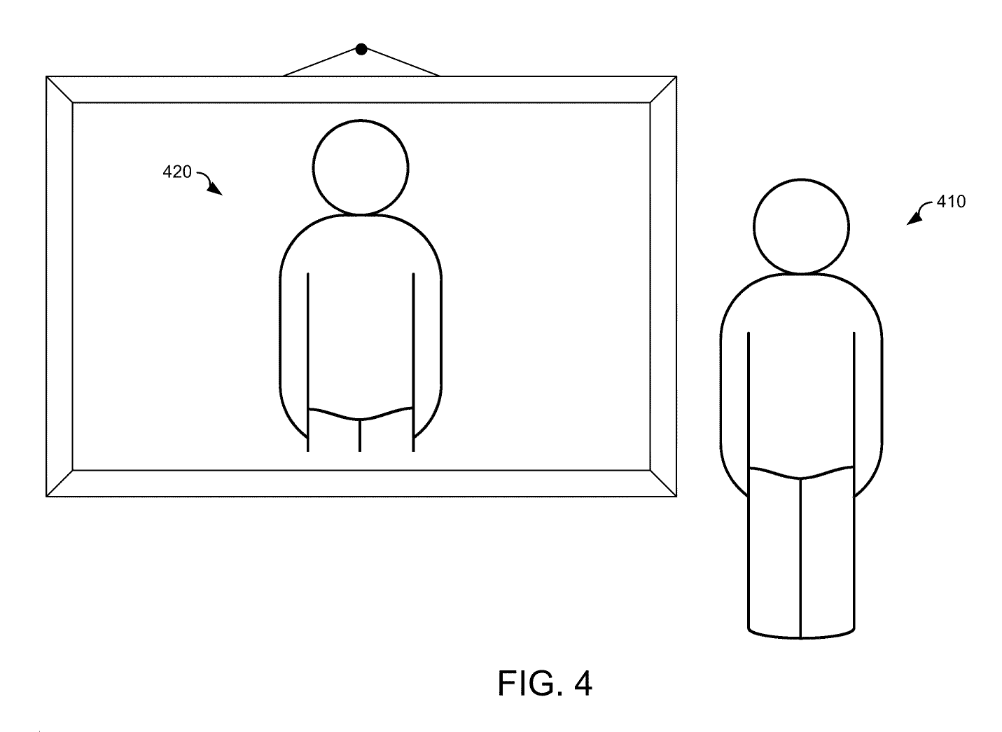

FIG. 4 is an illustration providing one example of a system for visualizing consequences of a player's choices in an embodiment of the present invention. In this example, a player is represented in the virtual world using avatar 410. Avatar 420 may be used to provide one or more visual indicators of a player's progress in a virtual world.

System 100 may provide a mechanism whereby feedback is given to the player based on player choices. As discussed above, a player's karma may be tracked using a “picture of Dorian Gray” method. For example, a player's avatar or in-world persona may be compared to “a picture of Dorian Gray” style visual representation wherein the picture change (e.g., ages) while the character stays ageless to reflect when a player's choices fail to satisfy the predetermined criteria. Avatar 420 for the player will become better or worse, older or younger, meaner or happier depending upon the results.

In some embodiments, to implement a “Dorian Gray” feature, system 100 maintains a dataset and map of a player's scores on a variety of SEL metrics. System 100 then utilizes one or more of the metrics generate or select story episodes and scenarios that play out as deserved Karma.

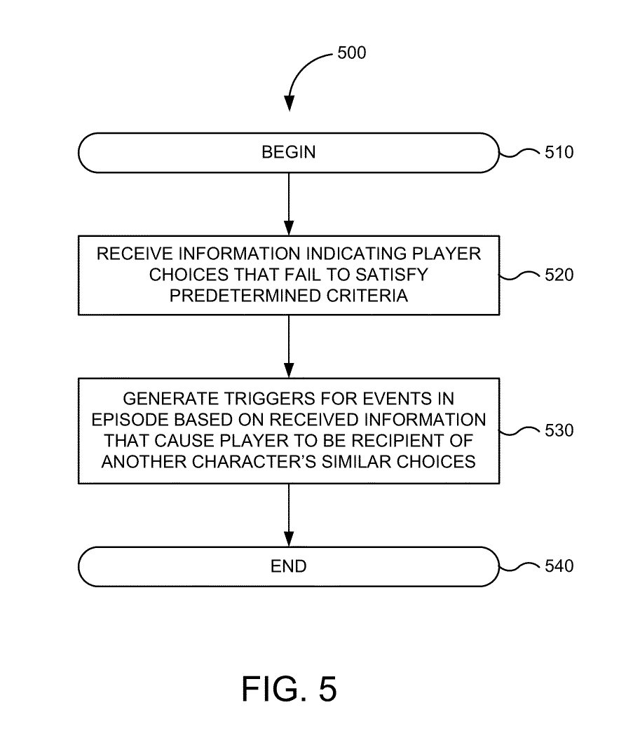

FIG. 5 is a simplified flowchart of method 500 implementing a programmable karma system in an embodiment of the present invention. Implementations of or processing in method 500 depicted in FIG. 5 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 500 depicted in FIG. 5 begins in step 510.

In step 520, information is received indicating player choices that fail to satisfy predetermined criteria. For example, system 100 provides a platform that enables experts in a variety of areas, from global warming to ethics, educators, mentors, and parents, to create games in a virtual world that teach a desired lesson by mapping SEL content into SEL episodes. System 100 tracks a player's choices and compares them to predetermined or desired outcomes of gameplay which may also be outlined in the SEL mapped content.

In step 530, one or more triggers are generated for events in the current or additional episode based on the received information that cause player to be recipient of another character's similar choices.

For example, system 100 incorporates a playback/“payback” feature akin to “programmable Karma” in which, after a player makes inaccurate, incomplete or erroneous SEL decisions (e.g., lacking empathy towards an NPC in a way that makes the NPC a victim of the situation), system 100 spawns a future event which, when it later takes place, causes the player to personally experience what happened to the NPC. This role-reversal facilitates helping the player experience results of another's choices in the same way that the player previously caused the NPC the experience. FIG. 5 ends in step 540.

Accordingly, in various embodiments, system 100 causes a NPC to mimic the earlier behavior of a player, including attitude, physical aggressiveness, dialogue and choices. System 100 then educates the player how the player failed (e.g., what the player did wrong). In some embodiments, system 100 provides the player with a time-travel option to return to the scene of the “crime” in order to change the player's behavior with an option to fix the future.

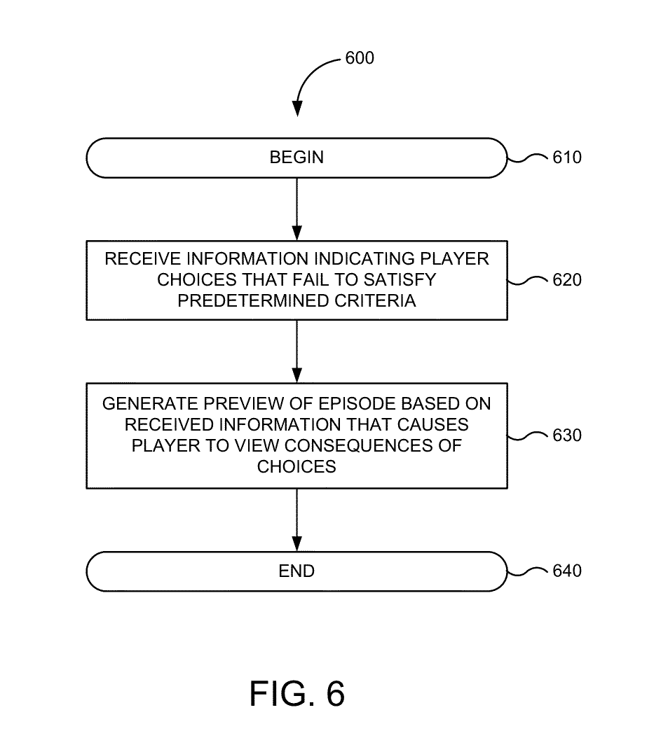

FIG. 6 is a simplified flowchart of method 600 implementing choice-consequence preview system in an embodiment of the present invention. Implementations of or processing in method 600 depicted in FIG. 6 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 600 depicted in FIG. 6 begins in step 610.

In step 620, information is received indicating player choices that fail to satisfy predetermined criteria. In step 630, a preview of an episode is generated based on the received information that causes player to view consequences of choices. For example, system 100 can also be programmed to take SEL decisions that the player has made and then time-travel into the future to show the player the effect of those decisions on the status of the environment. In some embodiments, the player is allowed to change the future by time-traveling back to change the original decisions. FIG. 6 ends in step 640.

In further embodiments, progress tracking can be applied to a game world in which a player operates. In one aspect, all players are put through a story “river” comprising chapters in the same order. System 100 takes measurements and tunes to assess how to speed or slow their flow down the river, adding and subtracting fat, adding hints or side-quests etc. Thus, in effect the virtual world remains engaging to each player as the player progresses at their own pace. In another example, some parts of a world are selectively opened and/or closed based on a player's progress. In one aspect, system 100 customizes gameplay for a player that rapidly advances through portions of the story in an attempt to slow the players progress while also remaining fun and challenging. System 100 adapts the look and feel of the gameplay to be “mature” enough to match a player. System 100 may allow moderate challenges to open up and “stretch” areas that can be seen on the map but not entered or used until the earlier challenges are met to entice slower moving players to remain motivated.

Thus, system 100 may incorporates one or more features that dynamically generate activities that keep players engaged in a virtual world. System 100 also may make a player feel unique in an age-appropriate world. System 100 may continue to adapt the player's world, including the player's avatar appearance, on the fly so that the player always feels at home and mature and is always stretching for the next level. System 100 endeavors to prevent the player from feeling like the player is stuck around “baby stuff” or things that are no longer uncool or entertaining because a younger sibling or cohort has copied them. Instead, system 100 includes episodes enabling the player to be moderately challenged by new things while “aspiring,” for example, to a next level or a higher grade level.

In some aspects, system 100 other elements that participate in the “aging” process for a player's world specifically can include not just NPC dialogue and consequences but scenery, other characters (popularity and features), choices and which areas are visible or not and open or not.

In yet another aspect, system 100 allows a player to experience conformity or uniqueness. For example, for younger age ranges, e.g., closer to age 5, a SEL challenge can be less stressful by allowing the player to find that the character, race, ethnicity etc. of the player's avatar is less unique. Specifically, in a world in which a character's “type”, e.g., “dog”, is represented by 70% of other characters in their world. However, as the player ages and advances the balance eventually may adapt to be 50-50 and at higher age ranges, e.g., 11, a player will regularly find that their character is a minority only represented by 30% of the other characters. From an SEL standpoint this adaptation allows for a reasonable amount of stress that is age-appropriate associated with being a minority group.

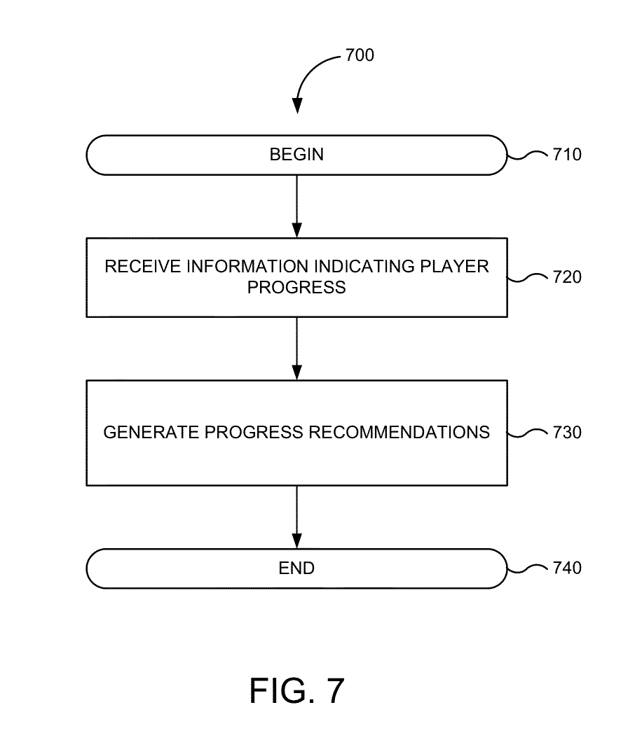

FIG. 7 is a simplified flowchart of a method for customizing episodic play in an embodiment of the present invention. Implementations of or processing in method 700 depicted in FIG. 7 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 700 depicted in FIG. 7 begins in step 710.

In step 720, information is received indicating player progress. In step 730, one or more progress recommendations are generated based on the received information. For example, system 100 can also be programmed to take SEL decisions that the player has made, the pace that the decisions are made, the number of interacts, time spend during one or more interactions, and the like and affect the pace or features of a user's experience. In some embodiments, system 100 takes measurements and tunes and customizes to assess how to speed or slow a user's flow through one or more SEL episodes, adding and subtracting aspects, adding hints or side-quests, or the like. FIG. 7 ends in step 740.

In further embodiments, system 100 provides a unique dashboard that shows game-related performance characteristics to a player (e.g., badges, weapons, hitpoints, prestige, popularity, gold coins available for use in buying stuff for the player's avatar). System 100 further shows a set of SEL metrics to a player's parent, guardian, teacher, or sponsor for monitoring a player's progress. Monitoring data may focus on how a player has recently achieved mastery over 7th level racism and 6th level global warming but is lagging at 3rd level in honesty and kindness. In one aspect, system 100 incorporates commentary embedded into an episode that is directed specifically to a player's parent, guardian, teacher, or sponsor for monitoring a player's progress in a separate dashboard. Such commentary may prompt a parent, for example, to ask their child how they succeeded at a specific tasks thereby reinforcing real-world teaching of the curriculum learned in the virtual world. In another aspect, episodic content may be directed specifically to a player's parent, guardian, teacher, or sponsor for monitoring a player's for other purposes, such as education, advice, or further study of a topic of interest.

In some embodiments, system 100 incorporates dashboard metric data and further customizes a new, dynamically adjusted player “lifeplan” such that the next rounds of episodes help the player “catch up” where needed. In addition, in some embodiments, a parent or teacher is provided with has a set of toggle switches where they can “double” the frequency of honesty episodes and censor/delete any episodes about another topic such as sex.

### CONCLUSION

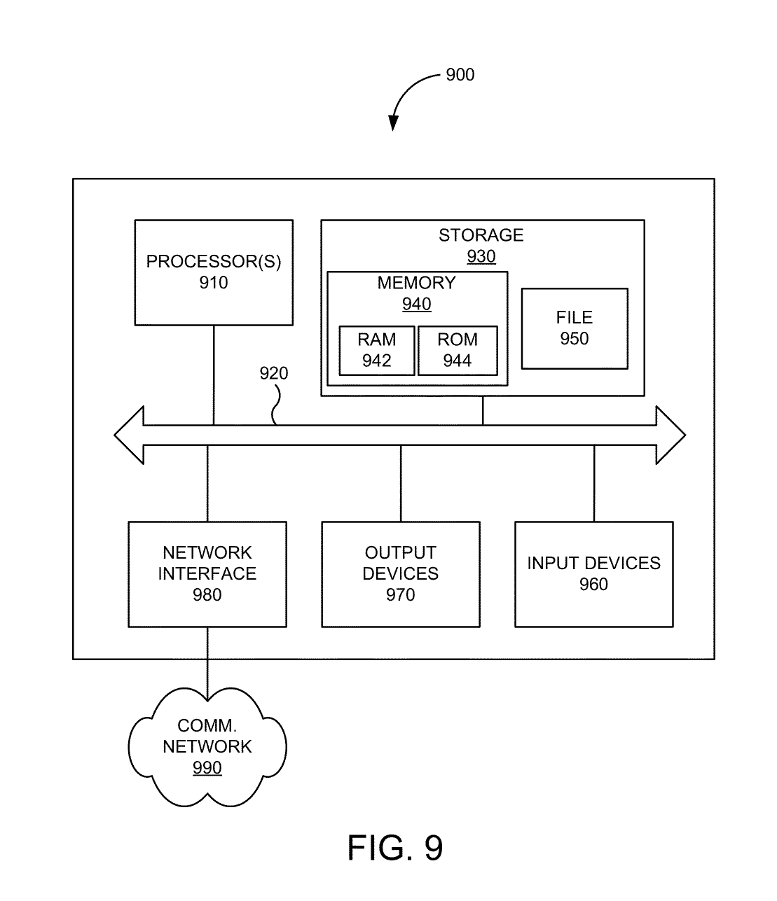

FIG. 9 is a simplified block diagram of computer system 900 that may be used to practice embodiments of the present invention. As shown in FIG. 9, computer system 900 includes processor 910 that communicates with a number of peripheral devices via bus subsystem 920. These peripheral devices may include storage subsystem 930, comprising memory subsystem 940 and file storage subsystem 950, input devices 960, output devices 970, and network interface subsystem 980.

Bus subsystem 920 provides a mechanism for letting the various components and subsystems of computer system 900 communicate with each other as intended. Although bus subsystem 920 is shown schematically as a single bus, alternative embodiments of the bus subsystem may utilize multiple busses.

Storage subsystem 930 may be configured to store the basic programming and data constructs that provide the functionality of the present invention. Software (code modules or instructions) that provides the functionality of the present invention may be stored in storage subsystem 930. These software modules or instructions may be executed by processor(s) 910. Storage subsystem 930 may also provide a repository for storing data used in accordance with the present invention. Storage subsystem 930 may comprise memory subsystem 940 and file/disk storage subsystem 950.

Memory subsystem 940 may include a number of memories including a main random access memory (RAM) 942 for storage of instructions and data during program execution and a read only memory (ROM) 944 in which fixed instructions are stored. File storage subsystem 950 provides persistent (non-volatile) storage for program and data files, and may include a hard disk drive, a floppy disk drive along with associated removable media, a Compact Disk Read Only Memory (CD-ROM) drive, a DVD, an optical drive, removable media cartridges, and other like storage media.

Input devices 960 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to computer system 900.

Output devices 970 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 900.

Network interface subsystem 980 provides an interface to other computer systems, devices, and networks, such as communications network 990. Network interface subsystem 980 serves as an interface for receiving data from and transmitting data to other systems from computer system 900. Some examples of communications network 990 are private networks, public networks, leased lines, the Internet, Ethernet networks, token ring networks, fiber optic networks, and the like.

Computer system 900 can be of various types including a personal computer, a portable computer, a workstation, a network computer, a mainframe, a kiosk, or any other data processing system. Due to the ever-changing nature of computers and networks, the description of computer system 900 depicted in FIG. 9 is intended only as a specific example for purposes of illustrating the preferred embodiment of the computer system. Many other configurations having more or fewer components than the system depicted in FIG. 9 are possible.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method for generating instructional games as described herein.

2. A non-transitory computer-readable medium for generating instructional games as described herein.

3. A system for generating instructional games as described herein.

4. A system for enabling non-programmers to create a game content episodes that conforms to a unique dialogue system.

5. A system configured to:
remember player choices;
create karma from the player choices;
provide one or more visual representations of the karma through a “picture of Dorian Gray” method;
show players, through the use of a computer-controlled “conscience avatar” what the players did and why it was wrong; and
enable the players to time travel into the future to see consequences or time travel into the past to repeat dialogue and decision tree branching to fix problems and correct the future.

6. The system of claim 5 wherein, for a player vs environment virtual world, stories and player missions can be added as episodes and the world is coded in such a fashion that only certain episodes of relevance to each player are exposed and the world dynamically reconfigures to have integrity and continuity within those choices.

7. The system of claim 6 wherein the world opens and closes sections based on the age or other elements of progress of the player or how the player's parent/guardian has made choices on a dashboard about which types of learning episodes to experience or not.

8. The system of claim 5 further comprising the ability to incorporate and onboard curriculum design from experts.

9. The system of claim 5 further comprising the ability to onboard story structures from famous human culture.

10. The system of claim 5 further comprising the ability to add or swap in and out game mechanics to maintain popularity.

11. The system of claim 5 further comprising the ability to scale world indefinitely due to structure of planets and planetside organization.

12. The system of claim 5 further comprising a theme park type layout organized to dynamically open or close elements based on player attributes.

13. The system of claim 5 further comprising a programmable dialogue system to allow moral lessons to be taught with consequences.

14. The system of claim 5 further comprising aging of avatars in many respects.

15. The system of claim 5 further comprising parallel dashboards, one with achievements for child from child's heroic perspective and one for parent with learning perspective.

16. The system of claim 5 further comprising parental controls over dynamic episodic content being included or excluded.

17. The system of claim 5 further comprising the ability of player to see, through their conscience spirit, what they did in the past that created a bad outcome.

18. The system of claim 5 further comprising the ability of player to go back and re-do with a makeover.

19. The system of claim 5 further comprising the ability of player to time travel forward or back to see consequences or fix problems.

20. The system of claim 5 further comprising the ability of player to be turned into different creatures and characters to walk in their shoes and feel their situation intimately.
